(19) United States
(12) Patent Application Publication
(10) Pub. No.: US 2017/0357910 A1
(43) Pub. Date: Dec. 14, 2017

(54) SYSTEM FOR ITERATIVELY TRAINING AN ARTIFICIAL INTELLIGENCE USING CLOUD-BASED METRICS

(71) Applicant: Apple Inc., Cupertino, CA (US)

(72) Inventors: Bruno M. Sommer, Cupertino, CA (US); Michael R. Brennan, Cupertino, CA (US); Norman N. Wang, Cupertino, CA (US); Ross R. Dexter, Cupertino, CA (US)

(21) Appl. No.: 15/334,692

(22) Filed: Oct. 26, 2016

Related U.S. Application Data
(60) Provisional application No. 62/348,486, filed on Jun. 10, 2016.

(51) Int. Cl. G06N 99/00

(52) U.S. Cl. CPC G06N 99/005

(57) ABSTRACT

A method may include receiving, at an artificial intelligence cloud service, a plurality of artificial intelligence feedback communications from a plurality of devices, wherein each artificial intelligence feedback communication of the plurality of artificial intelligence feedback communications includes data generated by software application components running on respective ones of the plurality of devices, the software application components including respective current artificial intelligence models, deriving, from the data included with each artificial intelligence feedback communication, an associated artificial intelligence model update for each of the respective current artificial intelligence models on the plurality of devices, and transmitting, to the plurality of devices, a plurality of artificial intelligence model update communications, wherein each artificial intelligence model update communication of the plurality of artificial intelligence model update communications includes the derived associated artificial intelligence model update for updating a corresponding one of the respective current artificial intelligence models on the plurality of devices.

### CLAIM OF PRIORITY

This application is a Non-Provisional of and claims the benefit of priority to U.S. Provisional Application Ser. No. 62/348,486, entitled “SYSTEM FOR ITERATIVELY TRAINING AN ARTIFICIAL INTELLIGENCE USING CLOUD-BASED METRICS,” filed on Jun. 10, 2016 which is hereby incorporated by reference herein in its entirety.

### TECHNICAL FIELD

Embodiments described herein generally relate to artificial intelligence and in particular, but without limitation, to training an artificial intelligence using cloud-based metrics.

### BACKGROUND

Many software applications rely on artificial intelligence (AI) to make decisions during normal operation. Games, in particular, use AI to determine state changes controlled by a computer, recommend state changes, and determine strategies. However, software applications are often unable to update the AI without a full and formal update to the software application. As a specific example, electronic games or other types of software that use AI features, components, etc., are available for sale or for free from on-line stores such as the Apple App Store. Once a user either buys or selects an App through the App Store, the software that runs the App is downloaded to the user's portable device (e.g., smart phone, etc.). In this case, updates to these Apps are only available through the App Store. Typically, the updates are available as version changes that fix several issues (e.g., bug fixes) or that provide improvements to the App. These updates are generated by the App developers and can only be pushed to the App owners through the App Store. As a result, App updates, and in particular AI updates, requiring developer generated updates frequently take a long time to get to the owners of the App. The resulting long update cycle time discourages users to continue using the faulty or non-satisfying App, which results in a loss of App usage and potentially developer income.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates a system for updating an Artificial Intelligence (AI) model, according to various embodiments;

FIG. 2 illustrates an AI cloud service, according to various embodiments;

FIG. 3 illustrates a flowchart of a method to update an Artificial Intelligence (AI) model, according to various embodiments;

FIG. 4 illustrates a flowchart of a method to use an updated an Artificial Intelligence (AI) model, according to various embodiments; and

FIG. 5 is a block diagram illustrating an example machine upon which any one or more of the techniques (e.g., methodologies) discussed herein may be performed, according to an example embodiment.

### DETAILED DESCRIPTION

Presented herein are systems and methods for iteratively training an artificial intelligence (AI) using metrics received via a network or cloud-based service. In the context of this disclosure, an AI is a simulated intelligence incorporating algorithms to satisfy conditions. AI in general in this disclosure may include aspects of machine learning, optimization using an objective function, incorporating feedback, or applying an algorithm to determine an output or set of outputs from an input or set of inputs. In this disclosure, an AI model includes algorithms to solve particular technical problems based on data generated by software application components. The AI model may be updated using feedback received from a device running a software application component that is using the AI model.

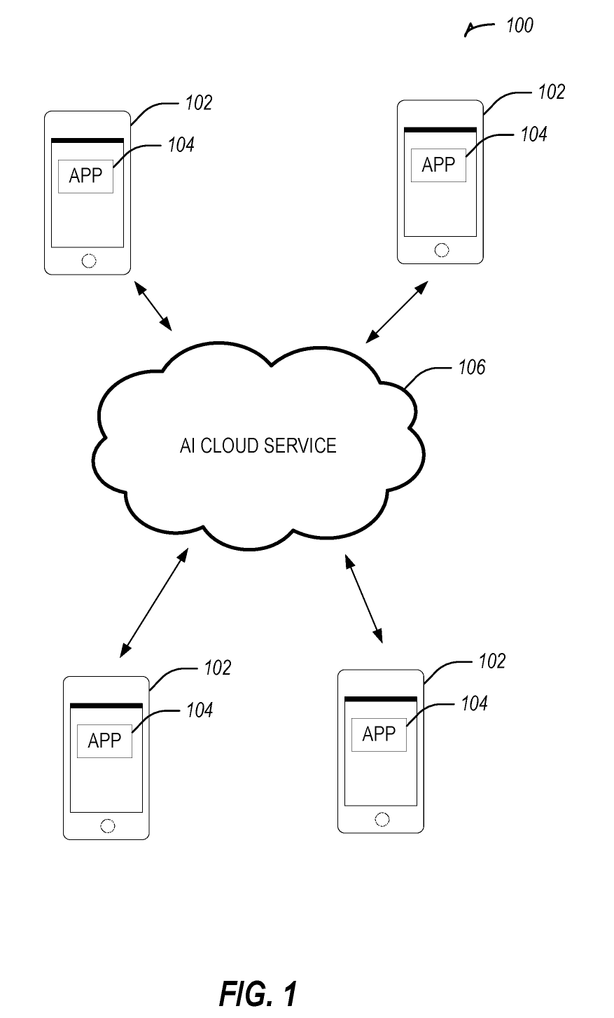

FIG. 1 illustrates a system 100 for updating an AI model, according to various embodiments. The system 100 includes a plurality of devices 102 running a plurality of software application components 104 (the devices may be the same type of device or different types of devices). The plurality of software application components 104 may be identical, entirely different (e.g., a game application and a map application), similar (e.g., different versions of a software application), or different components of a software application. The system 100 includes an AI cloud service 106, for example a network service running on a server, in communication with the plurality of devices 102.

The AI cloud service 106 of system 100 includes an automated process with intelligent controllers to determine an update to an AI model. For example, the AI cloud service 106 may use machine learning to update the AI model. As data is sent from the plurality of devices 102, the data related to the plurality of software application components 104, the AI cloud service 106 may apply the data to improve the AI model. For example, the AI cloud service 106 may determine whether a previous change to the AI model was effective in driving the software application components 104 to a desired change. The AI cloud service 106 may determine which updates were successful, and to what degree, as well as which updates were unsuccessful, and to what degree. The AI cloud service 106 may use machine learning to update AI models based on the relative determined success of past updates.

In another example, the AI cloud service 106 may run a simulation of various potential updates to an AI model to determine an update applicable to current objectives of the software application component. The current objectives may include improving speed, accuracy, precision, or processing time of the AI model. In another example, the AI cloud service 106 may update an AI model running on one of the plurality of devices 102 by replacing the AI model with a new AI model. Updating the AI models may include replacing or changing the plurality of AI models, such as replacing or changing particular algorithms run by one or more of the plurality of AI models. The updates may be done individually for each AI model of the plurality of AI models, may be dependent on the particular device running an AI model, may be dependent on the particular software application component using the AI model, may be dependent on the device and software application component, may be device independent, or may be software application component independent. For example, AI models may be used and updated for game-based software application components, such as different views in a game, potential moves, and other options. In another example, AI models may be applied to non-game-based software application components.

In an example, each different type of software application component (e.g., an application, an app, a game, a program, etc.) may have different criteria or parameters to build an individualized AI model. The information used to build the individualized AI model may be sent to the AI cloud service 106. The AI cloud service 106 may takes the information and determine an improvement to the AI. The AI cloud service 106 may then push the improvement to one or more of the plurality of devices 102 for use in one or more of the plurality of software application components 104. This process of updating the AI models used in the plurality of devices 102 may be done entirely in the cloud. As such, updating the AI models for use in the plurality of software application components 104 may be done without the need to rebuild the AI model from scratch. For example, the update to the AI models may be sent to the plurality of devices 102 without a full update to the plurality of software application components 104 themselves.

The AI cloud service 106 may take data sent by the plurality of devices and iteratively update respective AI models using the data. After updating the respective AI models to determine an update to the respective AI models, the update may be pushed back to the plurality of devices 102. The AI cloud service 106 may push the updated AI models to the plurality of devices 102 such that the plurality of devices 102 may avoid using the cloud to implement the AI models while running the software application components 104. For example, the push may include an identified change to an existing AI model on the plurality of devices 102 or may include an entirely new AI model for replacing an existing AI model.

In an example, a software application component may be used to rate restaurants. When a user input is received rating a restaurant 4 stars, for example, the device running the software application component may send the 4 star rating to the AI cloud service 106. The AI cloud service 106 may then use an algorithm to input the 4 star rating and create a new AI model or determine an update to an existing AI model. The AI model in this example may be used to recommend new restaurants based on past ratings. The AI model may be used by the device running the software application component to locally (i.e., without accessing a network) recommend a restaurant. The AI cloud service 106 may use data from the device only or from multiple devices to update the AI model (e.g., the AI model may be individualized to the device, or may harness data and improvements from multiple devices). The AI cloud service 106 may use data from the software application component only, or from multiple software application components (e.g., a first restaurant recommendation application and a second restaurant recommendation application may be used to update an AI model for the first, second, or both restaurant recommendation applications).

In an example, a developer of a software application component may predetermine desired updates to one or more AI models for use in the software application component. The developer may identify feedback metrics sent from devices to the AI cloud service 106. In another example, the developer may rely on the AI cloud service 106 to identify feedback metrics or determine update objectives. In another example, a developer or the AI cloud service 106 may configure when to update the AI model. For example, in a game-based software application component, the AI cloud service 106 may push an update to an AI model after a turn or state change. In another example, the AI cloud service 106 may push an update when a beacon wakes up the software application component, and the device sends a notification to the AI cloud service 106. In yet another example, real-time updates for an AI model may be pushed by the AI cloud service 106, for example every few milliseconds. For example, when the updates are incremental, real-time updates may be pushed by the AI cloud service 106.

The system 100 allows for updates to AI models for the plurality of software application components 104 running on the plurality of devices 102 without updating the plurality of software application components 104 entirely. This allows for fast and easy updating, for example by eliminating the need for quality assurance review, third-party approval, or formalized testing. Instead, the update may be sent as data to the plurality of devices 102 along with other data sent for the plurality of software application components 104. For example, the AI model update may include a change in data rather than a change in the underlying code of a software application component. In an example, the AI model is stored on each of the plurality of devices 102. The updated AI models may be used without a network connection after the update is received at the plurality of device 102.

In an example, the AI cloud service 106 may determine popular tactics or strategies in a game-based software application component and use them to update AI models. The determined popular tactics or strategies may have a time component, such as decaying weights. The AI model updates may be adapted to these tactics and strategies.

In an example, the plurality of software application components 104 may interact with different platforms. For example, the plurality of devices 102 may run different operating systems, different APIs, or different versions of a software application component. The AI cloud service 106 may receive data independently of the operating system, API, or version of the software application component used. The AI cloud service 106 may update an AI model based on data from all or a portion of the plurality of devices 102. For example, an AI model update may be based on data received from all of the plurality of devices 102. In another example, the AI model update may be based on data received only from devices running a particular version or versions of the software application component (e.g., a free version or a paid version of a software application component may use or receive different updates). In another example, the AI cloud service 106 may determine different updates to an AI model based on hardware or operating system of the devices.

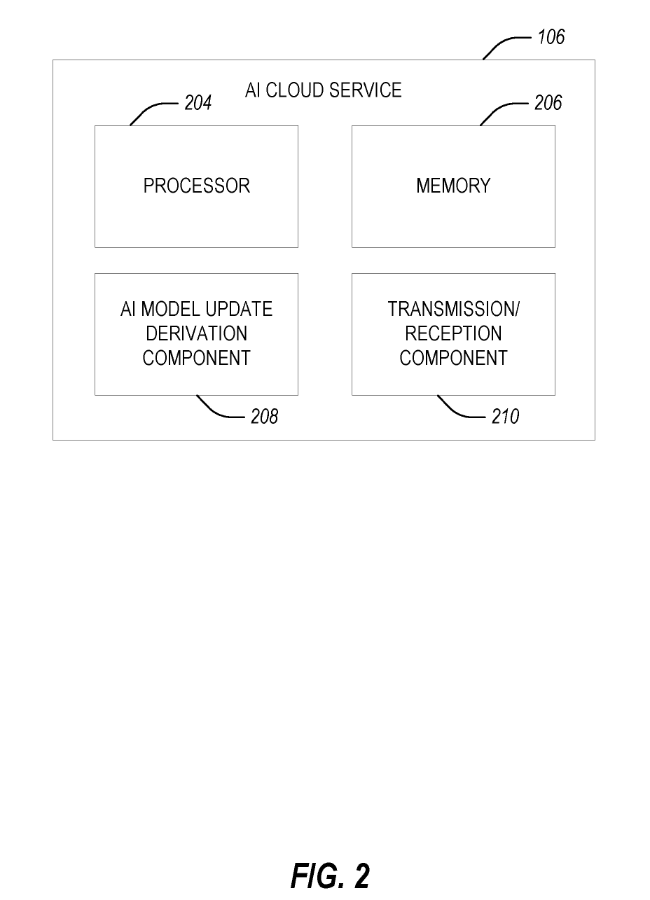

FIG. 2 illustrates the AI cloud service 106, according to various embodiments. The AI cloud service 106 includes a processor 204 and memory 206. The AI cloud service 106 includes AI model update derivation component 208 and transmission/reception component 210, which may be implemented by the processor 204. The AI cloud service 106 may be used to update AI models at a plurality of devices (e.g., plurality of device 102). The AI cloud service 106 may receive, using the transmission/reception component 210, a plurality of AI feedback communications from a plurality of devices, wherein each AI feedback communication of the plurality of AI feedback communications includes data generated by software application components running on respective ones of the plurality of devices, the software application components including respective current AI models. The AI cloud service 106 may derive, using the AI model update derivation component 208, from the data included with each AI feedback communication, an associated AI model update for each of the respective current AI models on the plurality of devices. The AI cloud service 106 may transmit, using the transmission/reception component 210, to the plurality of devices, a plurality of AI model update communications, wherein each AI model update communication of the plurality of AI model update communications includes the derived associated AI model update for updating a corresponding one of the respective current AI models on the plurality of devices.

In an example, the AI cloud service 106 may receive, using the transmission/reception component 210, data in a developer-defined or predetermined data structure, the data structure including information that is specific to a software application component. For example, a first software application component may have a different data structure including different feedback information than a second software application component. The AI model update derivation component 208 may use the data in the data structure to update an AI model. In an example, the AI cloud service 106 may use an update window to accumulate data from the devices. During a first update window, the transmission/reception component 210 may receive data from the devices. When the first update window ends, the AI model update derivation component 208 may take the accumulated data from during the first update window to determine an update to an AI model. The transmission/reception component 210 may then begin receiving new data for a second update window. The AI cloud service 106 may send the update to the devices based on the data from the first update window. The duration of an update window may be predefined, such as by a developer, and may be unique to a type of a device, unique to a type of software application component, unique to a version of a software application component, etc. While the AI model update derivation component 208 is determining an update, data received outside the duration window may be discarded or stored for future use and analysis by the AI model update derivation component 208.

In an example, the AI cloud service 106 may be unique to a specific software application component. For example, the transmission/reception component 210 may receive data from all devices running the specific software application component. In an example where the specific software application component has a number of released versions, for example 60% of devices running the specific software application component are using a version 2.0 and 40% of devices running the specific software application component are using a version 1.0, a first AI cloud service 106 or a first AI model update derivation component 208 may be used to determine updates to the specific software application component for version 2.0, and a second AI cloud service 106 or a second AI model update derivation component 208 may be used to determine updates to the specific software application component for version 1.0. In another example, a single AI cloud service 106 or a single AI model update derivation component 208 may be used for both versions unless significant changes have occurred in the specific software application component regarding the AI model used by the specific software application component from the version 1.0 to the version 2.0.

In an example, an AI model may include a neural net, a decision tree, a Markov model, or any other AI algorithm. The AI cloud service 106 may perform A/B testing on the AI model update. For example, the AI cloud service 106 may use the AI model update derivation component 208 to use multiple AI models and do A/B testing on the multiple AI models. The AI cloud service 106 may then use the transmission/reception component 210 to push the AI model update to one or more devices. In an example, the AI cloud service 106 may choose not to update an AI model on some devices, and update the AI model on other devices. For example, the AI cloud service 106 may selectively push an update to a subset of devices, such as to allow for live testing, give certain devices preferential treatment (e.g., in a paid version of a software application component), or the like. In another example, the AI cloud service 106 may push the AI model to all relevant devices.

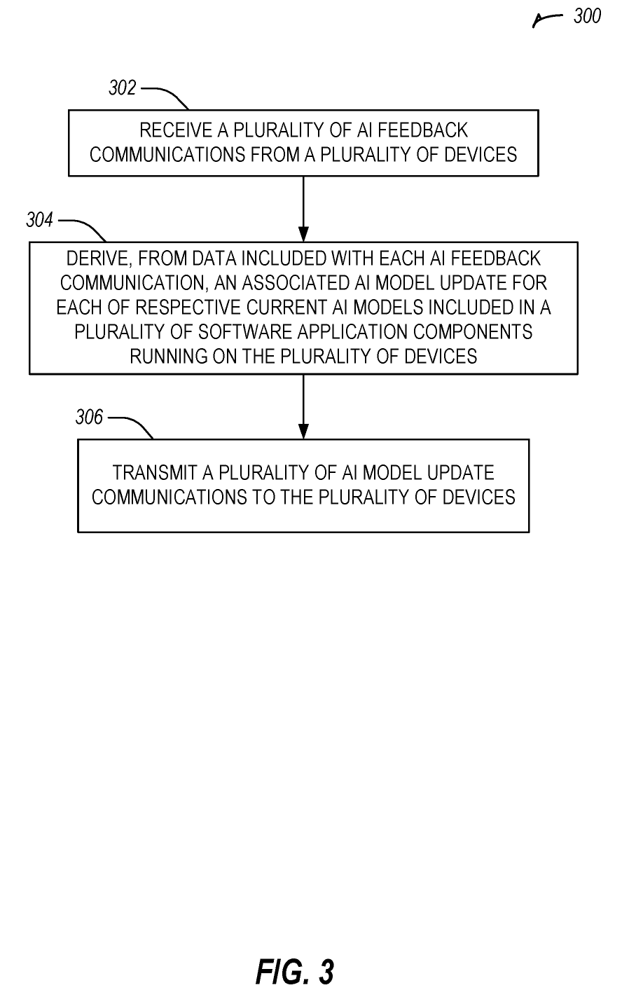

FIG. 3 illustrates a flowchart of a method 300 to update an Artificial Intelligence (AI) model, according to various embodiments. At operation 302, the method 300 includes receiving a plurality of AI feedback communications from a plurality of devices. In an example, the plurality of AI feedback communications include data generated by software application components running on respective ones of the plurality of devices, the software application components including respective current AI models.

At operation 304, the method 300 includes deriving, from the data included with each AI feedback communication, an associated AI model update for each of respective current AI models on the plurality of devices. In an example, a first device of the plurality of devices includes a first software application component of the software application components and a second device of the plurality of devices includes a second software application component of the software application components. The first and second software application components may be different or the same. In another example, the AI cloud service receives AI feedback communications from both the first software application component and the second software application component. Operation 304 may further include deriving a first associated AI model update for the first device and a second associated AI model update for the second device.

In an example, the plurality of devices includes two or more devices running first software application components. For example, the AI cloud service may receive AI feedback communications from each of the two or more devices running the first software application components. In another example, one of the respective current AI models is associated with the two or more devices.

In an example, the derived associated AI model update for updating a corresponding one of the respective current AI models on the two or more devices is a different derived associated AI model update for each of the two or more devices based on first software application component conditions on each of the two or more devices. In another example, the derived associated AI model update for updating a corresponding one of the respective current AI models on the two or more devices is the same derived associated AI model update for each of the two or more devices, such as when conditions are similar for the software application component running on the devices. In an example, the derived associated AI model update is unique to one of the plurality of devices. In another example, the derived associated AI model update is unique to a specific software application component of the software application components.

At operation 306, the method 300 includes transmitting a plurality of AI model update communications to the plurality of devices. In an example, the AI model update communications include the derived associated AI model update for updating a corresponding one of the respective current AI models on the plurality of devices. In an example, transmitting, to the plurality of devices, the plurality of AI model update communications, includes transmitting the plurality of AI model update communications at predetermined update times corresponding to software application component conditions of the software application components running on the plurality of devices. In an example, a device of the plurality of devices may be running two different software application components, an AI feedback communication for the device may include data generated by the two different software application components, and an AI model update communication for the device may include two different derived associated AI model updates for two current AI models corresponding to the two different software application components.

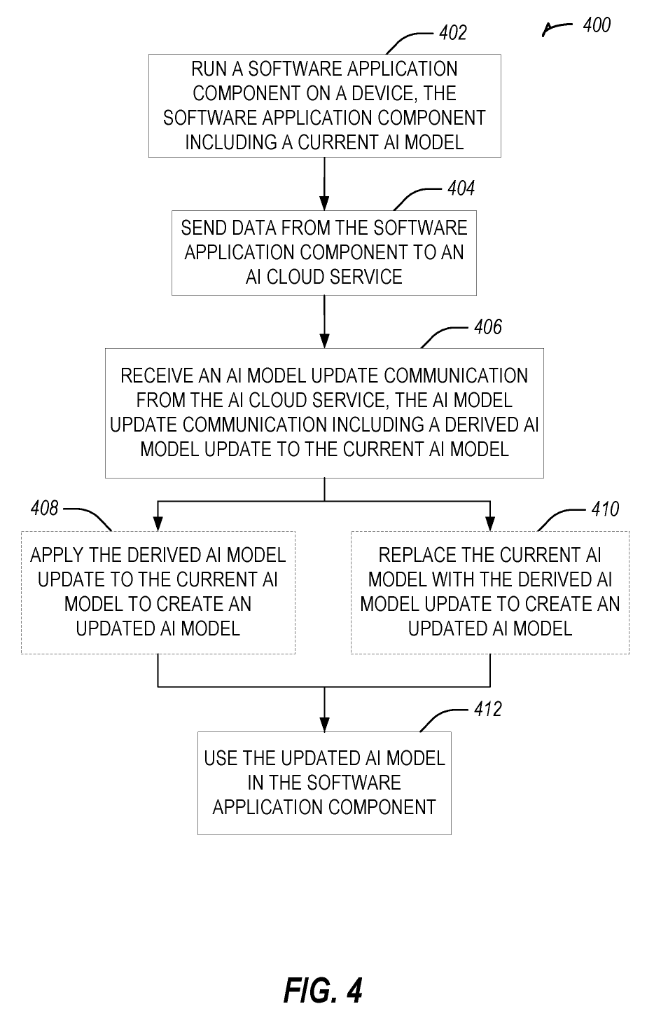

FIG. 4 illustrates a flowchart of a method to use an updated Artificial Intelligence (AI) model, according to various embodiments. At operation 402, the method includes running a software application component on a device, the software application component including a current AI model. At operation 404, the method includes sending data from the software application component to an AI cloud service. At operation 406, the method includes receiving an AI model update communication from the AI cloud service, the AI model update communication including a derived AI model update to the current AI model. At operation 408, the method optionally includes applying the derived AI model update to the current AI model to create an updated AI model. At operation 410, the method optionally includes replacing the current AI model with the derived AI model update to create an updated AI model.

At operation 412, the method includes using the updated AI model created in operation 408 or 410 in the software application component. To use the updated AI model in the software application component, the software application component may run scenarios or probabilities using the updated AI model on current state information of the software application component. For example, the software application component may use the updated AI model to determine and recommend a state change, to determine a computer-controlled state change, or determine and recommend a strategy (e.g., a plurality of state changes or a potential future state change).

### Example Computer System

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

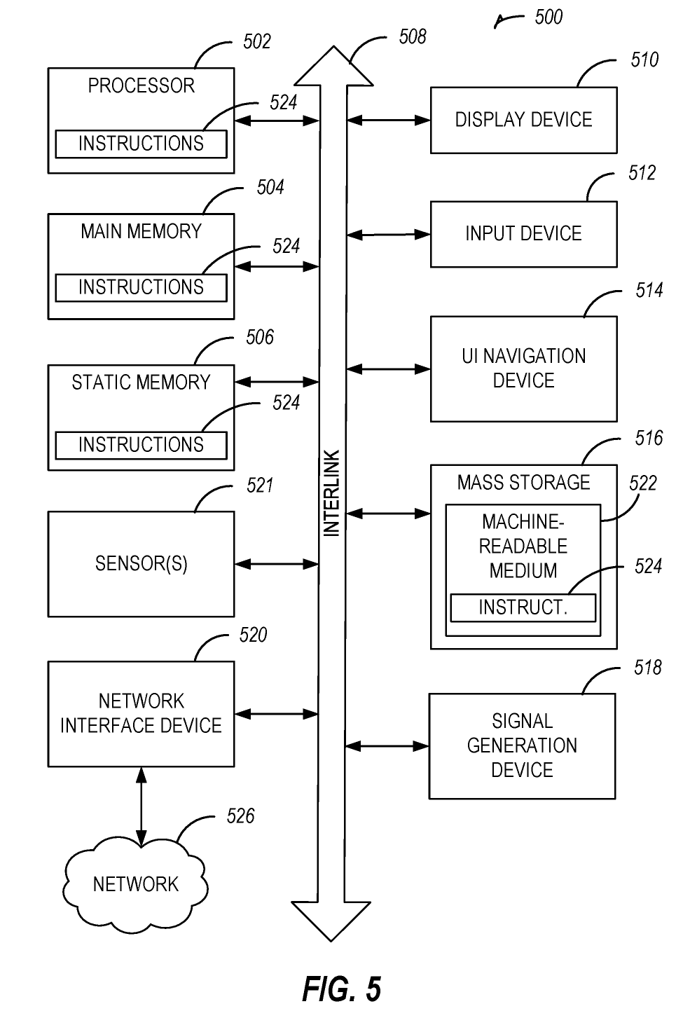

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method for updating an Artificial Intelligence (AI) model, the method comprising:
receiving, at an AI cloud service, a plurality of AI feedback communications from a plurality of devices, wherein each AI feedback communication of the plurality of AI feedback communications includes data generated by software application components running on respective ones of the plurality of devices, the software application components including respective current AI models;
deriving, from the data included with each AI feedback communication, an associated AI model update for each of the respective current AI models on the plurality of devices; and
transmitting, to the plurality of devices, a plurality of AI model update communications, wherein each AI model update communication of the plurality of AI model update communications includes the derived associated AI model update for updating a corresponding one of the respective current AI models on the plurality of devices.

2. The method of claim 1, wherein a first device of the plurality of devices includes a first software application component of the software application components and a second device of the plurality of devices includes a second software application component of the software application components;
wherein the first and second software application components are different; and
wherein the AI cloud service receives AI feedback communications from both the first software application component and the second software application component.

3. The method of claim 2, wherein deriving the associated AI model update for each of the respective current AI models includes deriving a first associated AI model update for the first device and a second associated AI model update for the second device.

4. The method of claim 1, wherein the plurality of devices includes two or more devices running first software application components and wherein the AI cloud service receives AI feedback communications from each of the two or more devices running the first software application components.

5. The method of claim 4, wherein one of the respective current AI models is associated with the two or more devices.

6. The method of claim 4, wherein the derived associated AI model update for updating a corresponding one of the respective current AI models on the two or more devices is a different derived associated AI model update for each of the two or more devices based on first software application component conditions on each of the two or more devices.

7. The method of claim 1, wherein the derived associated AI model update is unique to one of the plurality of devices.

8. The method of claim 1, wherein the derived associated AI model update is unique to a specific software application component of the software application components.

9. The method of claim 1, wherein transmitting, to the plurality of devices, the plurality of AI model update communications, includes transmitting the plurality of AI model update communications at predetermined update times corresponding to software application component conditions of the software application components running on the plurality of devices.

10. The method of claim 1, wherein:
a device of the plurality of devices is running two different software application components;
an AI feedback communication for the device includes data generated by the two different software application components; and
an AI model update communication for the device includes two different derived associated AI model updates for two current AI models corresponding to the two different software application components.

11. A system for updating an Artificial Intelligence (AI) model, the system comprising:
at least one processor;
a storage device comprising instructions, which when executed by the at least one processor, configure the at least one processor to:
receive, at an AI cloud service, a plurality of AI feedback communications from a plurality of devices, wherein each AI feedback communication of the plurality of AI feedback communications includes data generated by software application components running on respective ones of the plurality of devices, the software application components including respective current AI models;
derive, from the data included with each AI feedback communication, an associated AI model update for each of the respective current AI models on the plurality of devices; and
transmit, to the plurality of devices, a plurality of AI model update communications, wherein each AI model update communication of the plurality of AI model update communications includes the derived associated AI model update for updating a corresponding one of the respective current AI models on the plurality of devices.

12. The system of claim 11, wherein a first device of the plurality of devices includes a first software application component of the software application components and a second device of the plurality of devices includes a second software application component of the software application components;
wherein the first and second software application components are different; and
wherein the AI cloud service receives AI feedback communications from both the first software application component and the second software application component.

13. The system of claim 12, wherein the instructions to derive the associated AI model update for each of the respective current AI models include instructions to derive a first associated AI model update for the first device and a second associated AI model update for the second device.

14. The system of claim 11, wherein the plurality of devices includes two or more devices running first software application components and wherein the AI cloud service receives AI feedback communications from each of the two or more devices running the first software application components.

15. The system of claim 14, wherein one of the respective current AI models is associated with the two or more devices.

16. The system of claim 14, wherein the derived associated AI model update for updating a corresponding one of the respective current AI models on the two or more devices is a different derived associated AI model update for each of the two or more devices based on first software application component conditions on each of the two or more devices.

17. A non-transitory machine-readable medium comprising instructions, which when executed by at least one processor, configure the at least one processor to:
receive, at an AI cloud service, a plurality of AI feedback communications from a plurality of devices, wherein each AI feedback communication of the plurality of AI feedback communications includes data generated by software application components running on respective ones of the plurality of devices, the software application components including respective current AI models;
derive, from the data included with each AI feedback communication, an associated AI model update for each of the respective current AI models on the plurality of devices; and
transmit, to the plurality of devices, a plurality of AI model update communications, wherein each AI model update communication of the plurality of AI model update communications includes the derived associated AI model update for updating a corresponding one of the respective current AI models on the plurality of devices.

18. The machine-readable medium of claim 17, wherein a first device of the plurality of devices includes a first software application component of the software application components and a second device of the plurality of devices includes a second software application component of the software application components;
wherein the first and second software application components are different; and
wherein the AI cloud service receives AI feedback communications from both the first software application component and the second software application component.

19. The machine-readable medium of claim 17, wherein the derived associated AI model update is unique to one of the plurality of devices.

20. The machine-readable medium of claim 17, wherein the derived associated AI model update is unique to a specific software application component of the software application components.
